(19) United States
(12) Patent Application Publication
(10) Pub. No.: US 2014/0212682 A1
(43) Pub. Date: Jul. 31, 2014

(54) METALLIC FINE STRUCTURE AND PROCESSING METHOD THEREOF

(71) Applicants: Se Won Lee, Seoul (KR); Hong Shik Shin, Seoul (KR); Chong Nam Chu, Seoul (KR); Haan Kim, Seoul (KR); Sang Jae Shin, Seoul (KR)

(72) Inventors: Se Won Lee, Seoul (KR); Hong Shik Shin, Seoul (KR); Chong Nam Chu, Seoul (KR); Haan Kim, Seoul (KR); Sang Jae Shin, Seoul (KR)

(73) Assignee: SNU R&DB FOUNDATION, Seoul (KR)

(21) Appl. No.: 13/817,253

(22) PCT Filed: Feb. 10, 2012
(86) PCT No.: PCT/KR12/01021

§ 371 Date: Feb. 15, 2013

(30) Foreign Application Priority Data
Dec. 1, 2011 (KR) 10-2011-0127525

(51) Int. Cl. B23K 26/00

(52) U.S. Cl. CPC B23K 26/0084; B23K 26/0009
USPC 428/600; 219/121.66

(57) ABSTRACT

Provided is a method for manufacturing a metal structure in which an array of a plurality of pin arrangements is formed on a surface of a metal, in which the method includes: performing a laser processing along a route between pin regions in which the pins are to be formed on a metal base material to form a dross on the pin regions, and repeating the laser processing. As the dross formed in each pin region is repeatedly cast and recast during the repetitive laser processing, the recast layer is formed in a shape of the pin.

### TECHNICAL FIELD

The present invention relates to a metallic fine structure and a processing method thereof; and more particularly to a metallic fine structure having the arrangement of a plurality of pins formed on the surface of a metal, and a manufacturing method thereof.

### BACKGROUND ART

Generally, there are robots using a pin which is a thorn-like fine projection in order to climb a vertical wall. In practice, a robot using thorn-like fine projections is a robot which imitates a gecko lizard which forms adhesion on the wall by using a plurality of bristles called setae.

In practice, there are thin and long projections with a diameter of a hair, which is one-hundredth to one-thousandth of the thickness of a human hair, that is, thorn hairs or setae on a gecko lizard's foot bottom. The van der Waals' force (force which pulls electrically neutral molecules each other when they are at a very close distance from each other) acts between these fine setae and the wall surface. Although the force acting on each bristle is very weak, an adhesive force strong enough to sustain an enormous weight may be produced when a plurality of bristles are collected, and enables the gecko lizard to stick on the wall surface.

Furthermore, projections like spines are formed on the end of the leg of a beetle-imitating robot, and an attempt to allow the robot to move on a vertical wall surface has been made.

In order to actually implement the principle or attempt, a pin arrangement, which is finely processed on the surface of a metal, is required such that the pin arrangement may maintain durability while being attached to the vertical wall surface.

As shown in FIG. 1, Korean Patent Publication No. 10-2011-0104889 discloses a method for processing a shaped article having a ultrafine uneven structure on the surface thereof.

First, a substrate S is loaded onto the stage of a laser processing apparatus such that the substrate internal side Si is a processed surface.

Subsequently, a triangular prism pattern 1 is formed on the substrate internal side Si by performing a laser processing using a laser processing apparatus.

Subsequently, the substrate S rotates by 90 degrees in the scanning direction, and a block type processed shape 2 is formed on the substrate internal side Si by again performing the laser processing.

When seen from one direction, the block type processed shape 2 has a plane shape with a triangular shape 3, and has a block type shape 4 when seen from a direction orthogonal thereto.

Thereafter, a reflective film 5 is film-formed on a processed surface, on which a plurality of block type processed shapes 2 are formed, by a method such as vapor deposition and the like, a black color film 6 is added thereto for lining for the purpose of protecting the reflective action of the reflective film 5, then a protective film 7 is film-formed on a side opposite to the processed surface, and then a visual test is performed.

However, as the conventional method expands the reflection region of light by simply using laser, a gradation having complicated colors is only produced on the surface of a resin shaped article, and a pin arrangement is not finely processed on the surface of a metal with a high strength.

Although the conventional fine processing method for pin arrangement is performed only on a material such as polymer or silicon by using the semiconductor process, there are many problems in processing a pin arrangement having a very large aspect ratio as fine projections on the surface of a metal with a high strength such as, for example, stainless steel, tungsten steel or the like, that is, a long height while having a fine thickness thereof, through the method.

For example, when the surface of a metal such as stainless steel is laser-processed, a chromium oxide is produced during the laser processing. The remaining of the chromium oxide in a molten state on the processed surface without being vaporized and carried away during the processing thereof refers to dross, and dross acts as an element which should be suppressed from being produced by a method for blocking formation of oxide by spraying nitrogen, and the like because dross hinders the processing, and thus it is difficult to form a metallic fine structure for this reason.

### DISCLOSURE

### Technical Problem

In view of the above, the present invention provides a metallic fine structure in which a fine pin arrangement which is fine enough to be attached to a vertical wall surface on the surface of a metal and has a large aspect ratio and high strength, by using a dross and a recast layer, and a processing method thereof.

### Technical Solution

In accordance with an embodiment of the present invention, there is provided a method for manufacturing a metal structure in which an array of a plurality of pin arrangements is formed on a surface of a metal, the method including: performing a laser processing along a route between pin regions in which the pins are to be formed on a metal base material to form a dross on the pin regions; and repeating the laser processing. Further, as the dross formed in each of the pin regions is repeatedly cast and recast during the repetitive laser processing, the recast layer is formed in a shape of the pin.

Each of a plurality of the laser processing is performed in a first direction with respect to the metal base material and in a second direction orthogonal to the first direction along the route between the pin regions.

Each of a plurality of the laser processings is performed by a group of laser beams having a predetermined interval along the route between the pin regions.

Each of a plurality of the laser processings is repeated 1,500 times to 2,500 times.

Each of the pins has an aspect ratio with a height relatively larger than a width of the pin, the pin has a height relatively larger than a thickness of the metal base material, and each of the pins has a bottom having a wide cross-sectional area, and an upper distal end of the pin has a cone shape.

Each of the pins is able to move along a vertical direction, a horizontal direction and a slope direction with respect to the metal base material, and an interval between the pin regions is 10 μm to 200 μm, and an interval between the pins is 2 μm to 20 μm.

The metal base material includes stainless steel, and the metal base material includes tungsten steel.

In accordance with another embodiment of the present invention, there is provided a metallic fine structure characterized in that, in a metal structure in which an array of a plurality of pin arrangements is formed on a surface of a metal, a laser processing is performed along a route between pin regions in which the pins are to be formed on a metal base material to form a dross on each of the pin regions, and as the dross formed on each pin region is repeatedly cast and recast by repeatedly performing the laser processing, the recast layer is formed in a shape of the pin.

The metallic fine structure is used in a robot for attachment on a wall surface.

### ADVANTAGEOUS EFFECTS

According to the present invention, it is possible to provide a metallic fine structure, which is projected more than the thickness of a plate-like metal base material through dross considered as a hindrance element to the laser processing and is used to be attached to the wall surface in a wall surface-attaching robot or spinybot.

Furthermore, the present invention may normally process a metallic fine structure as laser processing conditions such as optimized repetition number and The like are found out through repetition of the laser processing.

In addition, the present invention may form a pin arrangement composed of a plurality of pins on a metal base material such as stainless steel, tungsten steel and the like, and thus is advantageous in excellent structural strength.

Furthermore, the present invention is advantageous in that it is possible to provide a metallic fine structure in which the upper distal end of each pin is relatively sharper than the bottom of the pin, and the shape of each pin is uniformly formed.

### DESCRIPTION OF DRAWINGS

FIG. 1 is a schematic perspective view for describing a processing method of a shaped article having a ultrafine uneven surface structure in accordance with the conventional technology;

FIG. 2 is a perspective view showing a metallic fine structure with a pin arrangement formed on the surface thereof in accordance with an embodiment of the present invention;

FIG. 3 is a photo of the metallic fine structure shown in FIG. 2;

FIG. 4 is a magnified photo of a metallic fine structure of stainless steel;

FIG. 5 is a magnified photo of a metallic fine structure of tungsten steel;

FIG. 6A is a flowchart for describing the processing method of the metallic fine structure of the present invention;

FIG. 6B is a view schematically illustrating the configuration of a laser processing apparatus which performs the processing method of FIG. 6A;

FIG. 7A is a schematic view showing a laser processing mode under the laser processing conditions in accordance with the present invention;

FIG. 7B is a single layer photo of the metallic fine structure formed in accordance with the laser processing conditions of FIG. 7A;

FIG. 8A is a schematic view showing a laser processing route under general laser processing conditions as a Comparative Example;

FIG. 8B is a single layer photo of the metallic fine structure formed in accordance with the general laser processing conditions of FIG. 8A as a Comparative Example;

FIG. 9 is a schematic view for describing the principle that a dross and a recast layer are used when the metallic fine structure is processed in accordance with the present invention; and

FIG. 10 is a photo showing a metal fine structure formed in accordance with the number of performing the processing under the laser processing conditions in accordance with the present invention.

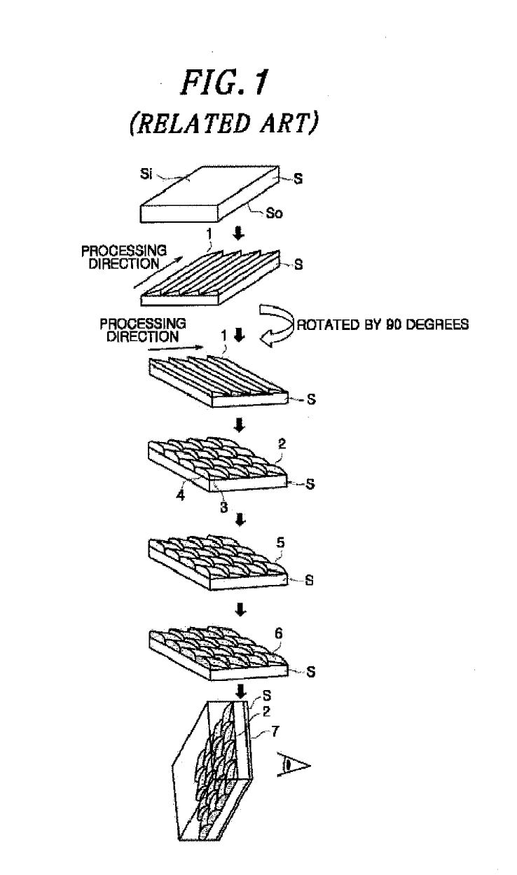

### BEST MODE

Hereinafter, embodiments of the present invention will be described in detail with reference to the accompanying drawings. Furthermore, when it is determined that specific description on known configurations or functions related in the description of the present invention may obscure the gist of the present invention, the detailed description thereof will be omitted. In particular, the configuration which may be understood as a technology which is the background of the invention, or which is similar in configuration, may not be included in the description of the present embodiment.

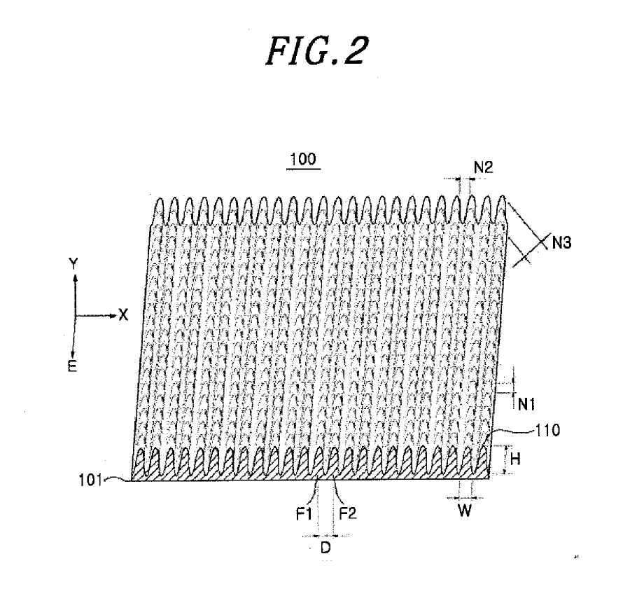

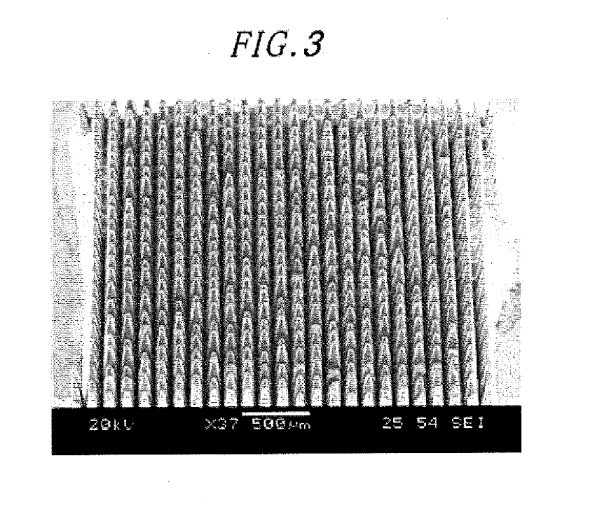

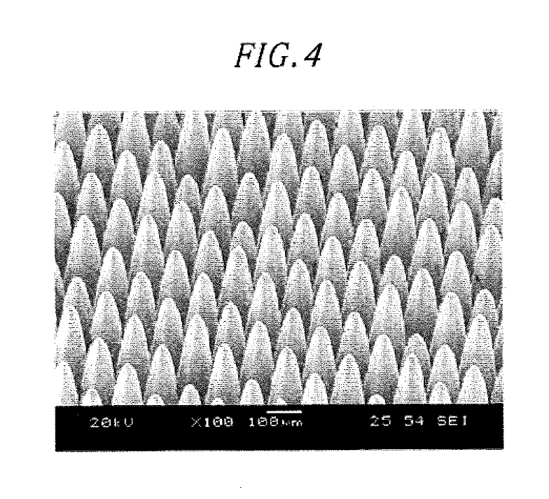

FIG. 2 is a perspective view showing a metallic fine structure which forms a pin arrangement in accordance with an embodiment of the present invention on the surface thereof, and FIG. 3 is a photo of the metallic fine structure shown in

FIG. 2.

Referring to FIG. 2, the metallic fine structure 100 in accordance with the present embodiment is formed by performing laser processing on the surface of a metal for being attached to the wall surface in a wall surface-attaching robot or spinybot in accordance with the processing method which will be described in detail below. The metal includes a metal which is a stainless steel or tungsten steel material and has an excellent structural strength.

As a dross is formed in the regions F1 and F2 in which a pin will be formed around the processing site by repeatedly performing the laser processing on the upper surface of a plate-like metal base material 101 along a plurality of laser processing routes set up in a lattice direction, a recast layer is formed as the dross formed in accordance with the laser processing is repeatedly cast and then recast, and the formed recast layer is overlapped in the form of pin, the metallic fine structure 100 includes the arrangement of a plurality of pins 110 formed spaced apart from each other on the surface of the metal base material 101.

As illustrated, the upper distal end of each pin 110 of the metallic fine structure 100 is relatively sharper than the bottom of the pin 110, and the shape of each pin 110 is uniformly formed.

The dross generated during the laser processing is a kind of chromium oxide produced in accordance with the laser processing of the metal base material 101 such as stainless steel and the like. The remaining of the chromium oxide in a molten state on the surface thereof without being vaporized and carried away refers to dross. In general, dross is an element which should be suppressed from being produced by a method for blocking formation of oxide by spraying nitrogen, and the like because dross hinders the processing. However, the dross in the present invention may be generated and cast in accordance with the laser processing for forming the arrangement of pins 110, may remain in a liquid state on the processed surface, and then may be cast and recast, thereby being formed as a recast layer on the smooth surface. That is, the dross in the present invention may contribute to formation of pins 110 through a repetitive overlapping of the recast layer.

When the surface of the metal base material 101 is defined as the X-Y plane, the pin in the metallic fine structure 100 is formed to be projected in the Z-axis direction vertical to the X-Y plane.

As the metallic fine structure is processed by the processing method of the metallic fine structure as described below, the intervals N1, N2 and N3 for securing a separated space which may move along the horizontal direction (for example, X-axis direction), the vertical direction (for example, Y-axis direction) and the slope direction (for example, X-Y axis direction) with respect to the surface of the metal base material 101 are formed between each pin 110, such that each pin 110 may move by elasticity. For example, the intervals N1, N2 and N3 between pins 110 are 2 to 20 μm, and the interval D between pin regions F1 and F2 is 10 to 200 μm.

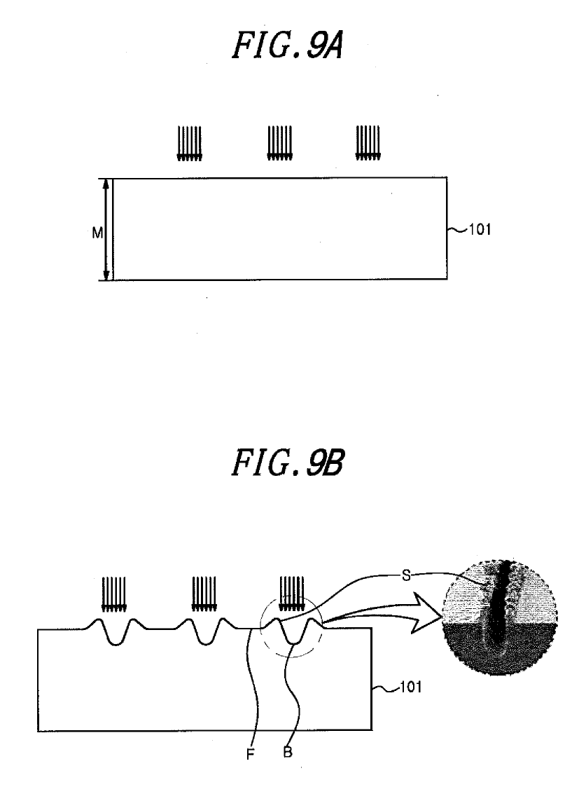

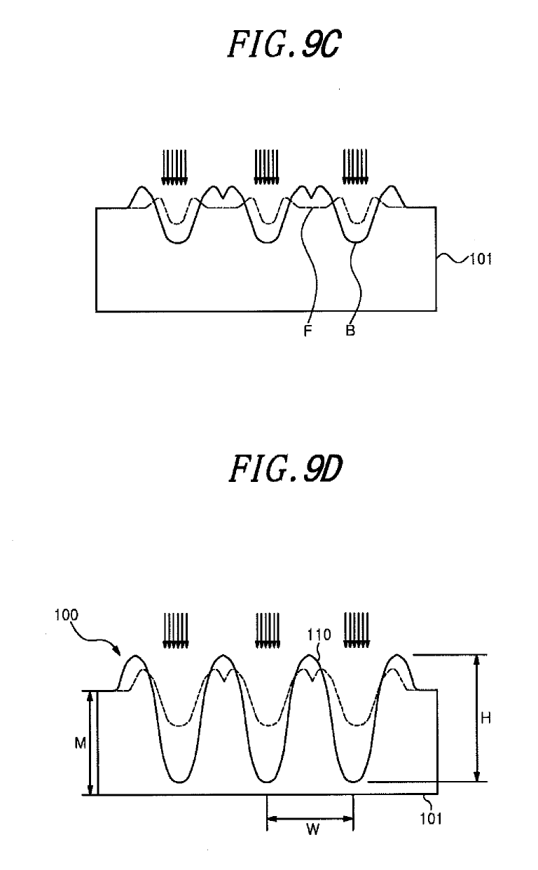

Furthermore, the pin 110 has an aspect ratio (H/W) in which the height H of the pin 110 is relatively larger than the width W thereof (for example, thickness of the bottom of the pin). For example, referring to FIG. 9, when the width W of the bottom of the pin 110 is 100 micrometers (μm), the length of the pin 100 corresponding to the height H of the pin 110 is three to five times larger than the width thereof and is formed relatively longer than the thickness M of the metal base material 101. As a Comparative Example, it is difficult to process a pin longer than the thickness M of the metal base material 101 while having a uniform height, but in the present invention, it is possible to process a pin 110 which is longer than the thickness M of the metal base material 101 and has a uniform height H by overlapping the recast layer.

In the pin 110 in accordance with the present invention, the bottom of the pin 110 has a wide cross-sectional area, and the upper distal end of the pin 110 has a narrow cross-sectional area or is formed in a pointed cone shape. Accordingly, a robot is stuck in a fine gap of the wall surface on which the robot is to move, and thus the pointed upper distal end of the pin 110 may enhance the moving performance of the robot.

As can be confirmed in FIG. 3, the metallic fine structure 100 has an arrangement structure composed of a plurality of pins, allows each pin 110 to be projected more upwardly than the thickness of the metal base material 101, and has an excellent structural strength as a stainless steel or tungsten steel material, thereby simultaneously enhancing the performance and durability of the wall surface-attaching robot or spinybot.

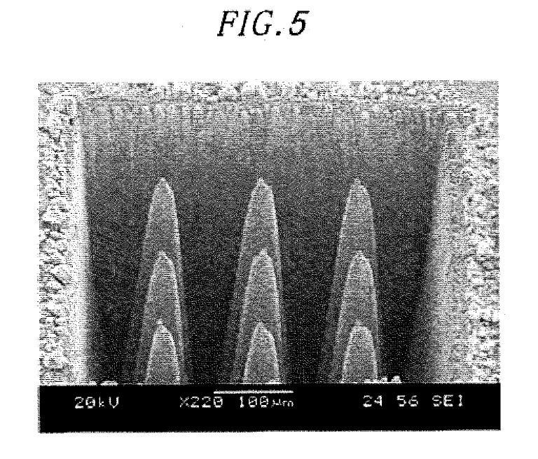

FIGS. 4 and 5 are magnified photos of the metallic fine structure, FIG. 4 is a magnified photo of a fine structure of stainless steel, and FIG. 5 is a magnified photo of a metallic fine structure of tungsten steel.

Referring to FIG. 4, it can be known that in each pin of the metallic fine structure, the upper distal end thereof is formed relatively sharply and uniformly.

Referring to FIG. 5, it can be known that even in the metal base material 101 of stainless steel as well as tungsten steel, the metallic fine structure of the present invention may be processed.

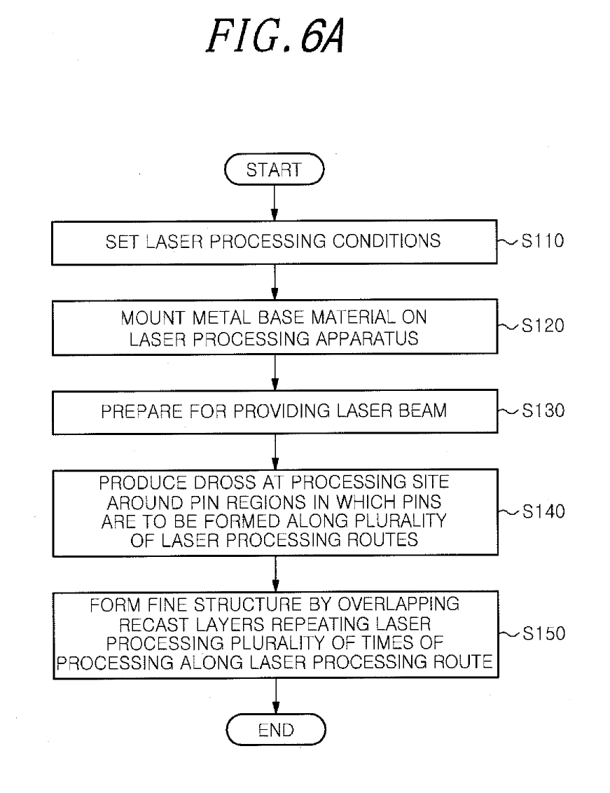

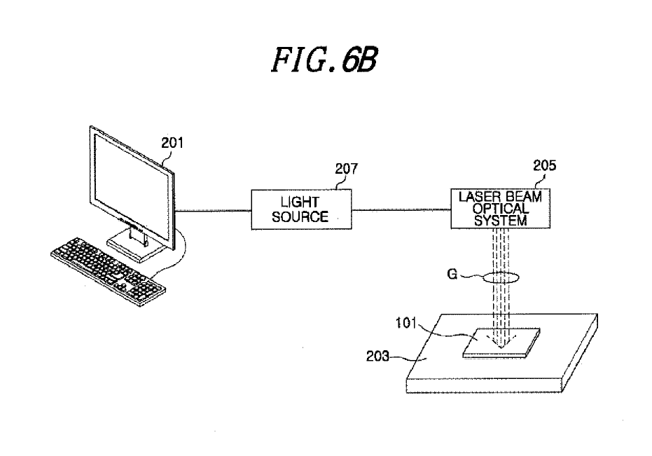

Hereinafter, referring to FIGS. 6A and 6B, the processing method of the metallic fine structure in accordance with the present embodiment will be described.

FIG. 6A is a flowchart for describing the processing method of the metallic fine structure of the present invention, and FIG. 6B is a view schematically illustrating the configuration of a laser processing apparatus which performs the processing method of FIG. 6A.

As illustrated in FIGS. 6A and 6B, the processing method of the metallic fine structure in accordance with the present embodiment includes: operation S100 of setting laser processing conditions, operation S120 of mounting a metal base material 101 on a laser processing apparatus, operation S130 of preparing for providing laser beam, operation S140 of producing a dross on pin regions in which pins are to be formed by performing a laser processing on the metal base material 101 by a group of laser beam at a processing site between the pin regions in which pins are to be formed along a laser processing route, and operation 5150 of forming a pin-like metallic fine structure 100 on the pin region by overlapping recast layers repeating the laser processing a plurality of times along the laser processing route.

In operation S110 of setting laser processing conditions, the laser processing conditions are inputted into a control unit 201 of the laser processing apparatus illustrated in FIG. 6B.

In operation S110 of setting laser processing conditions in, the laser processing conditions may be a laser processing mode, a laser beam having a maximum average output of 5 W and 20 kHz, a laser beam moving speed of 258.6 mm/s, and the like.

In embodiments of the present invention, the laser processing mode is a mode that repeatedly laser-processes the whole surface of the metal base material by using a group of laser beam in a first direction and a second direction orthogonal to the first direction along a processing site between pin regions in which pins are to be formed. In other words, the laser processing is repeatedly performed while moving a group of laser beam across in the horizontal and vertical direction on the top of the metal base material as in the lattice shape.

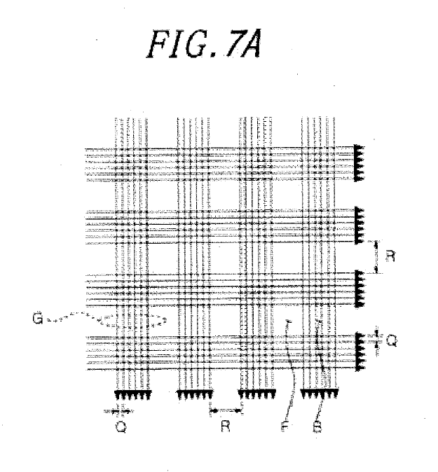

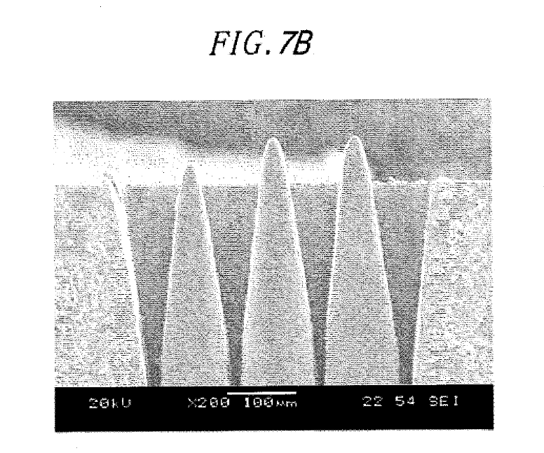

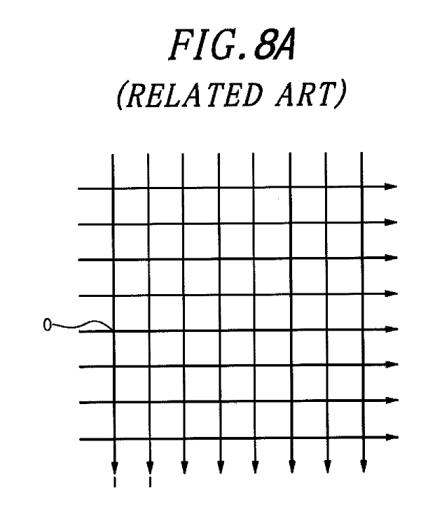

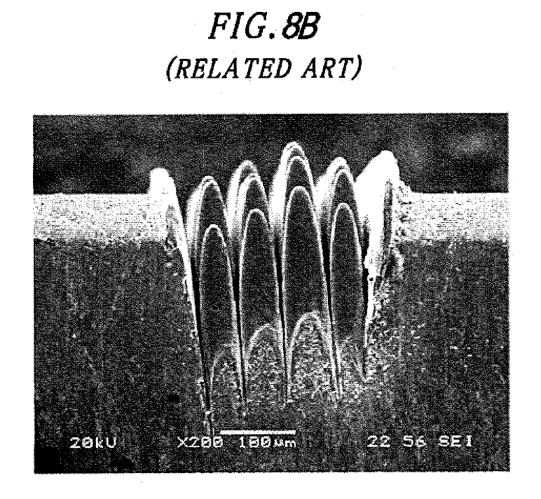

FIG. 7A is a schematic view describing the laser processing mode of the laser processing conditions in accordance with the present invention, and FIG. 7B is a single layer photo of the metallic fine structure formed in accordance with the laser processing conditions. In addition, FIG. 8A is a schematic view describing the laser processing mode of the general laser processing conditions as a Comparative Example, and FIG. 8B is a single layer photo of the metallic fine structure formed in accordance with the general laser processing conditions as a Comparative Example.

As illustrated in FIG. 7A, the arrow refers to each laser beam or route of laser beam, and a plurality of laser beams G spaced apart from each other and parallel to each other are composed of groups. A group of laser beams G may be composed of, for example, six laser beams. When the laser processing mode is repeatedly performed with the group of laser beams G on the metal base material 101 along the laser processing route between pin regions F, the metallic fine structure composed of a plurality of pin arrangements as in FIG. 7B may be formed while maintaining a separated space between pins 110. That is, it can be known that when the processing site B in FIG. 7A, corresponding to the space between pin regions F, is processed several times by using laser beams G, each long pin 110 may be obtained while maintaining a separated space between each other.

In accordance with the present embodiment, scanning the whole surface of the metal base material in the horizontal and vertical direction by a group of laser beam G along the laser processing route between pin regions F in which pins are to be formed on the metal base material 101 is defined as a one-time laser processing. Furthermore, the interval Q between laser beams in the group is 10 μm, the interval R between groups of laser beams G is 55 μm, and the number of performing laser processing is set as, for example, 1,500 times to 2,500 times.

On the contrary, referring to FIG. 8A, it can be known that when laser processing is performed while simply moving a single laser beam along the processing route O of laser beam in the form of simple lattice, processing is not achieved into a sufficient depth even though projections almost adhere to each other and the number of pins per area are large, and thus the length of the pin becomes short.

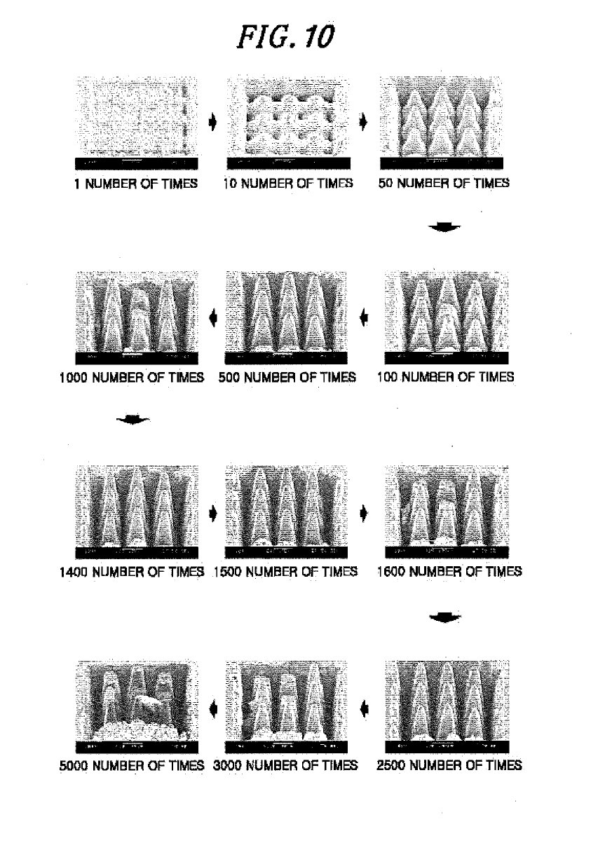

Meanwhile, FIG. 10 is a photo showing a metal fine structure formed in accordance with the number of performing the processing under the laser processing conditions in accordance with the present invention.

Referring to FIG. 10, the number of performing the processing indicates the number of repeatedly performing the metal base material by using a group of laser beams along the laser processing route.

The first photo in the top on the left side of FIG. 10 shows a processing site of a fine lattice structure, which corresponds to the one-time processing number.

Furthermore, the second photo shows a processing site having a gently curved lattice structure corresponding to the 10-time processing number.

In addition, when the photo with 1,500 times in the processing number is observed by comparing the shapes in the photo with the shapes in the photos with 1,400 times and 1,600 times, it can be known that a uniform, smooth and optimized metallic fine structure has been formed in the photo with 1,500 times.

That is, in the case of a processing with less than 1,500 times, a metallic fine structure with a height which may not be used in the wall surface-attaching robot, that is, a metallic fine structure with a height which is lower than the thickness of the metal base material is formed, and in the case of a processing with more than 1,500 times, defects that the distal end of the pin is cut off by performing the laser processing, the length of the pin becomes short or the like may be generated.

The observation of the shapes in the photo with 2,500 times in the processing number shows that pins may be regenerated, and from the observation of the shapes in the photos with 3,000 times and 5,000 times in the processing number, it can be known that defective shapes are obtained, so that a pin on one side affects a pin on the other side, pins are processed to shorten the lengths of the pins, or the like.

Therefore, values such as 1,500 times to 2,500 times in the processing number may be recognized to have a critical meaning.

Operation S120 of mounting a metal base material on a laser processing apparatus is an operation that mounts a metal base material 101 to be processed on a stage 203 of the laser processing apparatus.

Operation S130 of preparing for providing laser beam means that a laser beam optical system 205 is ready to be subjected to laser processing at a predetermined original point position under the control of the control unit 201 into which a set value corresponding to the laser processing conditions previously mentioned is inputted.

In operation S140 of producing a dross, as indicated in FIG. 7A, the laser processing is performed along the processing site B between pin regions F in which pins are to be formed, thereby producing a dross in the pin region F.

FIG. 9 is a schematic view for describing the principle that a dross and a recast layer are used when the metallic fine structure is processed in accordance with embodiments of the present invention.

Referring to FIG. 9, as illustrated in a portion (a) of FIG. 9, the metal base material 101 has a thickness M prepared in advance, and the laser processing is performed along the laser processing route in accordance with the laser processing mode. In this case, as illustrated in a portion (b) of FIG. 9, it can be known that the dross S is produced at the processing site B on the top of the metal base material 101.

In operation S150 of forming a metallic fine structure, as illustrated in the portion (b) of FIG. 9, when the processing site B between pin regions F is processed a plurality of laser processing numbers, it can be known that the overlapped recast layer is formed in a shape of pin 110, as illustrated in portions (c) and (d) of FIG. 9.

Here, the dross S at the processing site B forms a recast layer through repetitive melting and recasting and the recast layer is overlapped to cause the recast layer in a pin region F next to the processing site B to be overlapped, and as a result, it is possible to manufacture a metallic fine structure 100 composed of a plurality of pins 110 having a height H with a shape relatively longer than the thickness M of the metal base material 101.

While the invention has been shown and described with respect to the embodiments, the present invention is not limited thereto. It will be understood by those skilled in the art that various changes and modifications may be made without departing from the scope of the invention as defined in the following claims.

1. A method for manufacturing a metal structure in which an array of a plurality of pin arrangements is formed on a surface of a metal, the method comprising:
performing a laser processing along a route between pin regions in which the pins are to be formed on a metal base material to form a dross on the pin regions; and
repeating the laser processing,
wherein as the dross formed in each of the pin regions is repeatedly cast and recast during the repetitive laser processing, the recast layer is formed in a shape of the pin.

2. The method of claim 1, wherein each of a plurality of the laser processings is performed in a first direction with respect to the metal base material and in a second direction orthogonal to the first direction along the route between the pin regions.

3. The method of claim 1, wherein each of a plurality of the laser processings is performed by a group of laser beams having a predetermined interval along the route between the pin regions.

4. The method of claim 1, wherein each of a plurality of the laser processings is repeated 1,500 times to 2,500 times.

5. The method of claim 1, wherein each of the pins has an aspect ratio with a height relatively larger than a width of the pin, wherein the pin has a height relatively larger than a thickness of the metal base material.

6. The method of claim 5, wherein each of the pins has a bottom having a wide cross-sectional area, and an upper distal end of the pin has a cone shape.

7. The method of claim 1, wherein each of the pins is able to move along a vertical direction, a horizontal direction and a slope direction with respect to the metal base material.

8. The method of claim 5, wherein an interval between the pin regions is 10 μm to 200 μm, and an interval between the pins is 2 μm to 20 μm.

9. The method of claim 1, wherein the metal base material includes stainless steel.

10. The method of claim 1, wherein the metal base material includes tungsten steel.

11. A metallic fine structure characterized in that, in a metal structure in which an array of a plurality of pin arrangements is formed on a surface of a metal, a laser processing is performed along a route between pin regions in which the pins are to be formed on a metal base material to form a dross on each of the pin regions, and as the dross formed on each pin region is repeatedly cast and recast by repeatedly performing the laser processing, the recast layer is formed in a shape of the pin.

12. The method of claim 11, wherein the metallic fine structure is used in a robot for attachment on a wall surface.
